(19) United States
(12) Patent Application Publication
(10) Pub. No.: US 2005/0076746 A1
(43) Pub. Date: Apr. 14, 2005

(54) Wrench having greater torque

(76) Inventor: Chih-Ching Hsien, Taichung (TW)

Correspondence Address: Chih-Ching Hsien, 58, MA YUAN WEST ST., TAICHUNG, TW

(21) Appl. No.: 10/684,156

(22) Filed: Oct. 9, 2003

(51) Int. Cl. B25B 13/00

(52) U.S. Cl. 81/59.1

(57) ABSTRACT

A wrench includes a drive portion formed with a receiving portion, a ratchet wheel mounted in the receiving portion and formed with a plurality of oblique concave portions, and a plurality of rollers each movably mounted in a respective one of the oblique concave portions and each urged on a wall of the receiving portion. An included angle defined between a bottom face of each of the oblique concave portions and a horizontal line of the drive portion is ranged from 5 and 30 degrees. Thus, the resultant driving force of the wrench passes through the ratchet wheel having a greater thickness, so that the wrench produces the maximum torque during operation.

### BACKGROUND OF THE INVENTION

1. Field of the Invention

The present invention relates to a wrench, and more particularly to a wrench having a greater torque.

2. Description of the Related Art

A conventional wrench in accordance with the prior art shown in FIG. 5 comprises a wrench body 10 having an end formed with a drive portion 11 formed with a receiving portion 12, a ratchet wheel 13 mounted in the receiving portion 12 of the drive portion 11 and having a periphery formed with a plurality of oblique concave portions 14, and a plurality of rollers 15 each movably mounted in a respective one of the oblique concave portions 14 of the ratchet wheel 13 and each urged on a wall of the receiving portion 12 of the drive portion 11. Each of the oblique concave portions 14 of the ratchet wheel 13 has a first end formed with a deeper concave portion 141 and a second end formed with a shallower concave portion 142.

In operation, when the drive portion 11 of the wrench body 10 is rotated in the normal direction, each of the rollers 15 is rolled into the shallower concave portion 142 of a respective one of the oblique concave portions 14 of the ratchet wheel 13 and is urged on the wall of the receiving portion 12 of the drive portion 11, so that the ratchet wheel 13 is combined with the drive portion 11 of the wrench body 10 to rotate therewith. Thus, the ratchet wheel 13 is rotated by rotation of the drive portion 11 of the wrench body 10 so as to rotate a screw member (not shown) mounted in the ratchet wheel 13.

Alternatively, when the drive portion 11 of the wrench body 10 is rotated in the reverse direction, each of the rollers 15 is rolled into the deeper concave portion 141 of a respective one of the oblique concave portions 14 of the ratchet wheel 13 and is detached from the wall of the receiving portion 12 of the drive portion 11, so that the ratchet wheel 13 is detached from the drive portion 11 of the wrench body 10. Thus, the drive portion 11 of the wrench body 10 idles in the reverse direction.

Referring to FIGS. 6 and 7 with reference to FIG. 5, a horizontal line “C” passes through the center of the drive portion 11 of the wrench body 10, and a line “D” passing through the bottom face of the oblique concave portion 14 of the ratchet wheel 13 is parallel with the horizontal line “C”, so that the bottom face of the oblique concave portion 14 of the ratchet wheel 13 is parallel with the horizontal line “C” of the drive portion 11 of the wrench body 10.

A tangential force Fₜ is produced between each of the rollers 15 and the wall of the receiving portion 12 of the drive portion 11, and has a tangential point “s” with each of the rollers 15. In addition, the wall of the receiving portion 12 of the drive portion 11 produces a reaction force Fᵣ on each of the rollers 15, and the reaction force Fᵣ is directed toward the center of the receiving portion 12 of the drive portion 11 and passes through the tangential point “s”. Thus, the tangential force Fₜ and the reaction force Fᵣ form a resultant force F_{R} of the conventional wrench.

However, the resultant force F_{R} of the conventional wrench only passes through a rim of the ratchet wheel 13, so that the conventional wrench has a smaller torque during operation. Thus, the conventional wrench easily slips from the screw member during operation due to a smaller torque.

### SUMMARY OF THE INVENTION

The primary objective of the present invention is to provide a wrench having a greater torque.

Another objective of the present invention is to provide a wrench, wherein the resultant driving force of the wrench passes through the ratchet wheel having a greater thickness, so that the wrench produces the maximum torque during operation.

A further objective of the present invention is to provide a wrench which produces the maximum torque during operation, thereby preventing the wrench from slipping from the screw member due to a smaller torque.

In accordance with the present invention, there is provided a wrench, comprising a wrench body having an end formed with a drive portion formed with a receiving portion, a ratchet wheel mounted in the receiving portion of the drive portion and having a periphery formed with a plurality of oblique concave portions, and a plurality of rollers each movably mounted in a respective one of the oblique concave portions of the ratchet wheel and each urged on a wall of the receiving portion of the drive portion, wherein:
an included angle is defined between a bottom face of each of the oblique concave portions of the ratchet wheel and a horizontal line of the drive portion of the wrench body.

Preferably, the included angle is ranged from 5 and 30 degrees.

Further benefits and advantages of the present invention will become apparent after a careful reading of the detailed description with appropriate reference to the accompanying drawings.

### BRIEF DESCRIPTION OF THE DRAWINGS

FIG. 1 is a partially plan cross-sectional view of a wrench in accordance with the preferred embodiment of the present invention;

FIG. 2 is a plan view of a drive portion of the wrench as shown in FIG. 1;

FIG. 3 is a locally plan view of the drive portion of the wrench as shown in FIG. 2;

FIG. 4 is another locally plan view of the drive portion of the wrench as shown in FIG. 2;

FIG. 5 is a partially plan cross-sectional view of a conventional wrench in accordance with the prior art;

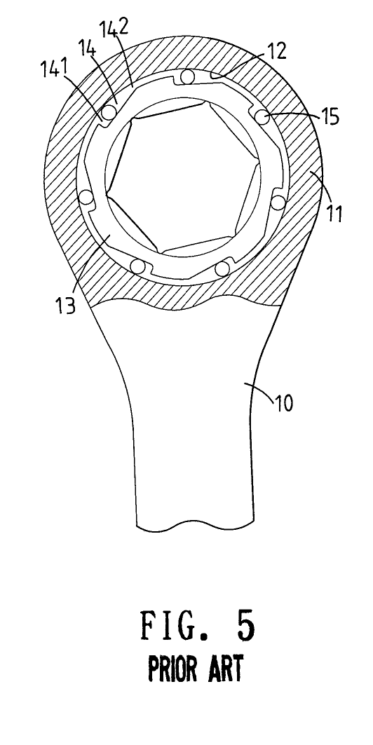

FIG. 6 is a plan view of a drive portion of the conventional wrench as shown in FIG. 5; and

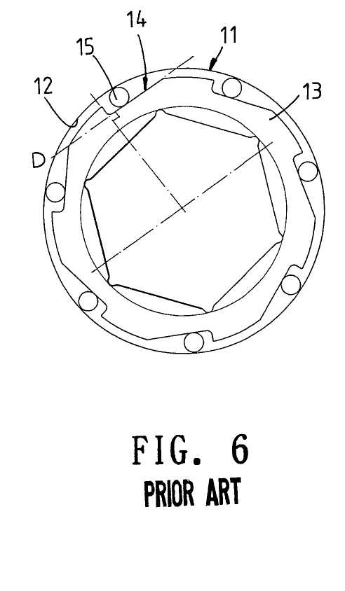

FIG. 7 is a locally plan view of the drive portion of the conventional wrench as shown in FIG. 6.

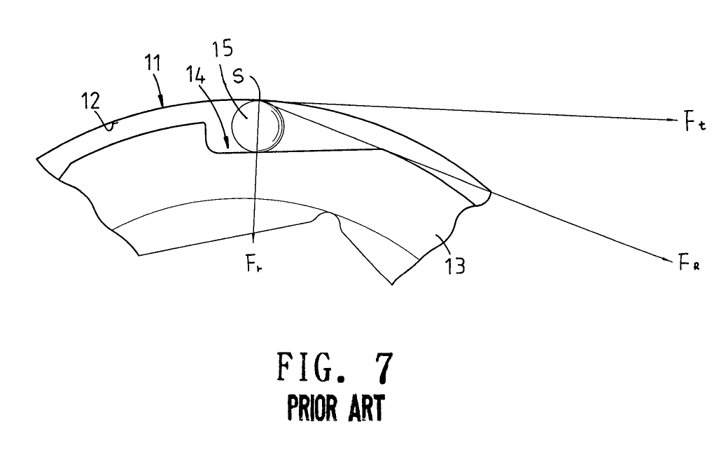

### DETAILED DESCRIPTION OF THE INVENTION

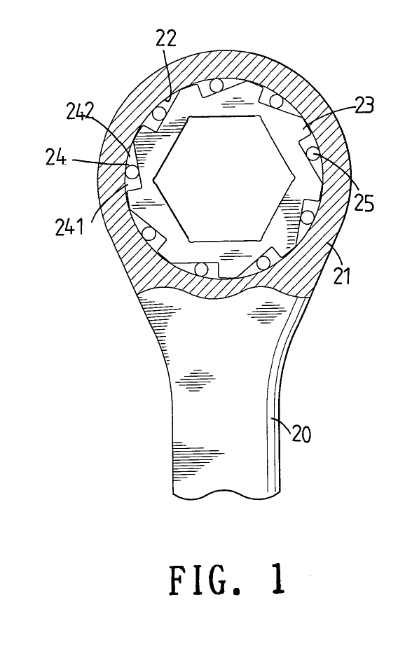

Referring to the drawings and initially to FIG. 1, a wrench in accordance with the preferred embodiment of the present invention comprises a wrench body 20 having an end formed with a drive portion 21 formed with a receiving portion 22, a ratchet wheel 23 mounted in the receiving portion 22 of the drive portion 21 and having a periphery formed with a plurality of oblique concave portions 24, and a plurality of rollers 25 each movably mounted in a respective one of the oblique concave portions 24 of the ratchet wheel 23 and each urged on a wall of the receiving portion 22 of the drive portion 21. Each of the oblique concave portions 24 of the ratchet wheel 23 has a first end formed with a deeper concave portion 241 and a second end formed with a shallower concave portion 242.

In operation, when the drive portion 21 of the wrench body 20 is rotated in the normal direction, each of the rollers 25 is rolled into the shallower concave portion 242 of a respective one of the oblique concave portions 24 of the ratchet wheel 23 and is urged on the wall of the receiving portion 22 of the drive portion 21, so that the ratchet wheel 23 is combined with the drive portion 21 of the wrench body 20 to rotate therewith. Thus, the ratchet wheel 23 is rotated by rotation of the drive portion 21 of the wrench body 20 so as to rotate a screw member (not shown) mounted in the ratchet wheel 23.

Alternatively, when the drive portion 21 of the wrench body 20 is rotated in the reverse direction, each of the rollers 25 is rolled into the deeper concave portion 241 of a respective one of the oblique concave portions 24 of the ratchet wheel 23 and is detached from the wall of the receiving portion 22 of the drive portion 21, so that the ratchet wheel 23 is detached from the drive portion 21 of the wrench body 20. Thus, the drive portion 21 of the wrench body 20 idles in the reverse direction.

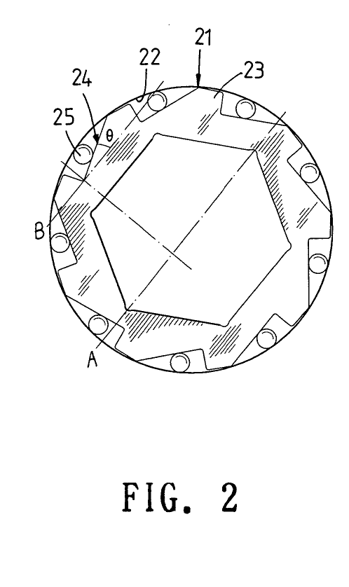

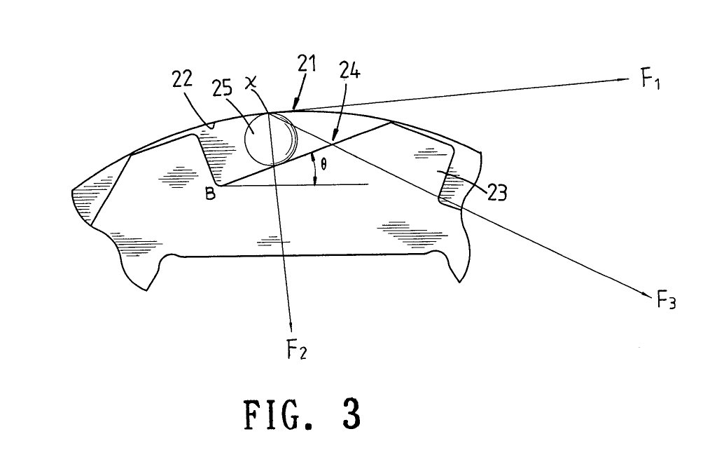

Referring to FIGS. 2 and 3 with reference to FIG. 1, a horizontal line “A” passes through the center of the drive portion 21 of the wrench body 20, and a horizontal line “B” passes through a bottom of one of the oblique concave portions 24 of the ratchet wheel 23 and is parallel with the horizontal line “A”, so that an included angle θ is defined between a bottom face of the oblique concave portion 24 of the ratchet wheel 23 and the horizontal line “B”. Preferably, the included angle θ is ranged from 5 and 30 degrees.

A tangential force F1 is produced between each of the rollers 25 and the wall of the receiving portion 22 of the drive portion 21, and has a tangential point “x” with each of the rollers 25. In addition, the wall of the receiving portion 22 of the drive portion 21 produces a reaction force F2 on each of the rollers 25, and the reaction force F2 is directed toward the center of the receiving portion 22 of the drive portion 21 and passes through the tangential point “x”. Thus, the tangential force F1 and the reaction force F2 form a resultant force F3 which passes through the ratchet wheel 23.

As shown in FIG. 3, the included angle θ between the bottom face of the oblique concave portion 24 of the ratchet wheel 23 and the horizontal line “B” is ranged from 5 and 30 degrees, so that the resultant force F3 will pass through the bottom face of the oblique concave portion 24 of the ratchet wheel 23. Thus, the resultant force F3 passes through the ratchet wheel 23 having a greater thickness, so that the wrench can produce the maximum torque during operation.

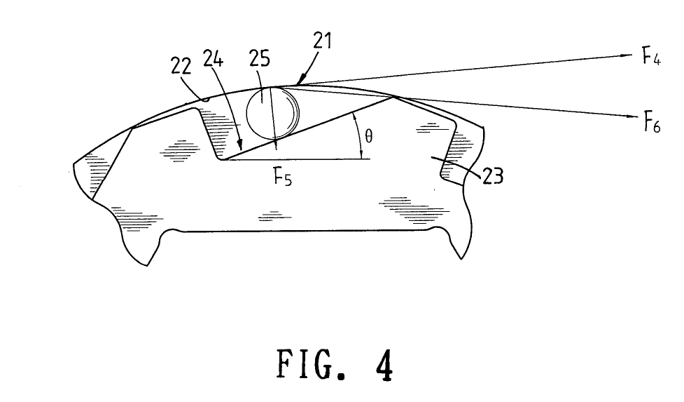

As shown in FIG. 4, a tangential force F4 is produced between each of the rollers 25 and the wall of the receiving portion 22 of the drive portion 21. In addition, the wall of the receiving portion 22 of the drive portion 21 produces a smaller reaction force F5 on each of the rollers 25, and the reaction force F2 is directed toward the center of the receiving portion 22 of the drive portion 21. Thus, the tangential force F4 and the smaller reaction force F5 form a resultant force F6 which is more horizontal. At this time, the included angle θ between the bottom face of the oblique concave portion 24 of the ratchet wheel 23 and the horizontal line “B” is ranged from 5 and 30 degrees, so that the resultant force F6 will still pass through the bottom face of the oblique concave portion 24 of the ratchet wheel 23. Thus, the resultant force F6 passes through the ratchet wheel 23 having a greater thickness, so that the wrench can produce the maximum torque during operation.

Accordingly, the resultant driving force of the wrench will pass through the ratchet wheel having a greater thickness, so that the wrench can produce the maximum torque during operation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wrench, comprising a wrench body having an end formed with a drive portion formed with a receiving portion, a ratchet wheel mounted in the receiving portion of the drive portion and having a periphery formed with a plurality of oblique concave portions, and a plurality of rollers each movably mounted in a respective one of the oblique concave portions of the ratchet wheel and each urged on a wall of the receiving portion of the drive portion, wherein:
an included angle is defined between a bottom face of each of the oblique concave portions of the ratchet wheel and a horizontal line of the drive portion of the wrench body.

2. The wrench in accordance with claim 1, wherein the included angle is ranged from 5 and 30 degrees.

3. The wrench in accordance with claim 1, wherein the horizontal line of the drive portion of the wrench body passes through a center of the drive portion of the wrench body.

4. The wrench in accordance with claim 1, wherein the wrench has a resultant driving force passing through the ratchet wheel.

5. The wrench in accordance with claim 1, wherein the wrench has a resultant driving force passing through the bottom face of one of the oblique concave portions of the ratchet wheel.
